(19) United States
(12) Patent Application Publication
(10) Pub. No.: US 2018/0189360 A1
(43) Pub. Date: Jul. 5, 2018

(54) Methods and apparatus to present information from different information systems in a local record

(71) Applicant: General Electric Company, Schenectady, NY (US)

(72) Inventors: Jessica Wadsworth Bolduc, South Burlington, VT (US); Michael R. Jones, South Burlington, VT (US)

(21) Appl. No.: 15/932,237

(22) Filed: Feb. 16, 2018

Related U.S. Application Data
(63) Continuation of application No. 14/091,928, filed on Nov. 27, 2013.

(51) Int. Cl. G06F 17/30

(52) U.S. Cl. CPC G06F 17/30545

(57) ABSTRACT

Example systems, methods and machine readable storage media to present information from different information systems in a local record are disclosed herein. An example method includes initiating communication with a first information system and a second information system, the first information system connected to a local system via a local network, the second information system connected to the local system via an external network. The example method also includes utilizing an identifier to identify a first query key associated with the first information system and a second query key associated with the second information system. The example method also includes generating a local record in the local system, importing first patient information from the first information system via the first query key to the local record, and importing second patient information from the second information system via the second query key to the local record.

### RELATED APPLICATIONS

This patent arises from a continuation of U.S. patent application Ser. No. 14/091,928, filed on Nov. 27, 2013, which is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND

Healthcare practitioners may review medical exam results stored in information systems such as hospital information systems (HIS), radiology information systems (RIS), clinical information systems (CIS), cardiovascular information systems (CVIS), etc., and storage systems such as picture archiving and communication systems (PACS), library information systems (LIS), and electronic medical records (EMR). Information stored can include patient medication orders, medical histories, imaging data, test results, diagnosis information, management information, and/or scheduling information, for example. The healthcare practitioners may obtain the information from information systems included in the healthcare environment, such as hospitals or clinics, in which the practitioner practices (e.g., local information systems) or from information systems included in other healthcare environment(s) (e.g., foreign information system(s)).

### BRIEF SUMMARY

Example systems, methods and tangible machine readable storage media to present information from different information systems in a local record are disclosed herein.

An example method to present information for a patient from a first information system and a second information system at a local system is disclosed herein. An example method to present information for a patient from a first information system and a second information at a local system includes initiating communication with the first information system and the second information system, the first information system connected to the local system via a local network, the second information system connected to the local system via an external network. The example method also includes utilizing a patient identifier to identify a first query key associated with the first information system and a second query key associated with the second information system. The example method also includes generating a local record in the local system, importing first patient information from the first information system via the first query key to the local record, and importing second patient information from the second information system via the second query key to the local record.

An example system to present information for a patient from different information systems at a local system is also disclosed herein that includes a session handler to initiate communication with a first information system and a second information system, the first information system to be connected to the local system via a local network, the second information system to be connected to the local system via an external network. The example system also includes a query manager to utilize a patient identifier to identify a first query key that is associated with the first information system and to identify a second query key that is associated with the second information system. The example system also includes a record manager to generate a local record in the local system. The example system also includes a data importer to import first patient information from the first information system via the first query key to the local record, and the data importer to import second patient information from the second information system via the second query key to the local record.

Also disclosed herein is a machine readable storage medium comprising instructions that, when executed, cause a machine to at least initiate communication with a first information system and a second information system, the first information system connected to a local system via a local network, the second information system connected to the local system via an external network. The example instructions also cause the machine to utilize a patient identifier to identify a first query key associated with the first information system and a second query key associated with the second information system. The example instructions also cause the machine to generate a local record in the local system, import first patient information from the first information system via the first query key to the local record, and import second patient information from the second information system via the second query key to the local record.

### BRIEF DESCRIPTION OF SEVERAL VIEWS OF THE DRAWINGS

FIG. 1 illustrates a block diagram of an example data aggregation system in an example healthcare system.

FIG. 2 illustrates a block diagram of the example data aggregation system of FIG. 1.

FIG. 3 is an example data table representing a state of information imported by the example data aggregation system of FIGS. 1 and/or 2.

FIG. 4 is an example data table representing another state of information imported by the example data aggregation system of FIGS. 1 and/or 2.

FIG. 5 is a flowchart representative of example machine readable instructions that may be executed to initiate the example data aggregation system of FIGS. 1 and/or 2.

FIG. 6 is a flowchart representative of example machine readable instructions that may be executed to monitor user input at the example data aggregation system of FIGS. 1 and/or 2.

FIG. 7 is a flowchart representative of example machine readable instructions that may be executed to terminate local information at the example data aggregation system of FIGS. 1 and/or 2.

FIG. 8 is a block diagram of an example processing platform capable of executing the example machine readable instructions of FIGS. 5-7 to implement the example data aggregation system of FIGS. 1 and/or 2.

The foregoing summary, as well as the following detailed description of certain examples of the present invention, will be better understood when read in conjunction with the appended drawings. For the purpose of illustrating the invention, certain examples are shown in the drawings. It should be understood, however, that the present invention is not limited to the arrangements and instrumentality shown in the attached drawings.

### DETAILED DESCRIPTION OF CERTAIN EMBODIMENTS

Although the following discloses example methods, systems and machine readable media including, among other components, software and/or firmware executed on hardware, it should be noted that such methods and apparatus are merely illustrative and should not be considered as limiting. For example, it is contemplated that any or all of these hardware, software, and firmware components could be embodied exclusively in hardware, exclusively in software, or in any combination of hardware and software. Accordingly, while the following describes example methods, systems, and machine readable media, persons of ordinary skill in the art will readily appreciate that the examples provided are not the only way to implement such methods, systems and machine readable media.

The present disclosure relates generally to healthcare applications, and, more particularly, to methods and apparatus to present information from different information systems in a local record.

Many healthcare environments include radiology information systems to facilitate patient examination and/or patient diagnosis. For example, a radiology information system in a healthcare system can store radiology reports, messages, warning, alerts, patient scheduling information, patient demographic data, patient tracking information, and/or physician and patient status monitors.

A medical exam may be ordered for a patient, and the medical exam is assigned to a practitioner (e.g., a radiologist) to interpret the exam. For example, a technician may perform the exam (e.g., take x-rays of the patient), and the radiologist may analyze the medical images and clinical symptoms to provide his or her interpretation of the results of the exam. A medical exam interpreted by a healthcare practitioner (e.g., a radiologist) can involve review by the healthcare practitioner to obtain, for example, diagnostic information from the exam. In a hospital setting, medical exams can be ordered for a plurality of patients, all of which involve review by an examining practitioner. Each exam may have associated attributes, such as a modality, a part of the human body under exam, and/or an exam priority level related to a patient criticality level. In some examples, however, not all the information needed for reviewing a medical exam is locally available. For example, a practitioner (e.g., a nurse, a radiologist, a registrar or a technician) may want to review information about a patient, but the information may be spread across different information systems and/or across different healthcare institutions.

In some systems, the practitioner may review printouts of the information from the different information systems. However, the printouts may not include up-to-date information. For example, information in an information system may be updated to include a new resting heart rate for the patient. In some systems, the practitioner may access the information from the different information systems by manually connecting to each of the necessary information systems. This cumbersome process of logging into an information system whenever information from that information system is needed can cause the practitioner to obtain the information less frequently. Thus, the practitioner may review the medical exam (or record) for the patient with stale information.

In some systems, a healthcare institution builds a unified system that includes all the data from the different information systems. For example, the unified system can be populated with all the information stored in a first hospital information system, a second hospital information system, a radiology information system, etc. Such unified systems necessitate large databases to store all of the information. Further, transforming the information (e.g., cleansing, reformatting, standardizing, aggregating and/or applying any number of business rules) from the different information systems into a single format as needed for the unified system can be impractical. For example, each of the different information systems may be controlled by different business rules or service level agreements, store the information in different formats, include different definitions for optional elements versus required elements, include different data validation requirements, apply different rules to highlight fields of interest, check different rules if a local record meets the criteria for the next milestone, supply different lists of values, etc. In addition, if the information is transformed at the unified system, returning the data (e.g., information updated by the practitioner) to the source information system can be unreasonable. For example, two healthcare institutions storing patient information in different formats can merge and build a unified system storing patient information from each of the healthcare institutions. In some such examples, the patient information is transformed into a common format when stored in the unified system. However, if the merged healthcare institutions decide to separate into the two different healthcare institutions, separating the data for the respective healthcare institutions can be impractical.

Disclosed and described herein are example systems, methods and machine readable media that enable collecting information from different information systems at a local system and presenting the information to a user without importing the information for permanent storage at the local system. To this end, examples disclosed herein query local and/or foreign information systems with a query key(s) for a patient and import information from each of the respective information systems regarding the patient. The imported information is accessible to the local system without first transforming the information into a common format, and the local (e.g., imported) information is presented (e.g., displayed) to the user. Thus, examples disclosed and described herein enable returning information from different information systems to their respective source information systems without a complicated transformation process. In some examples, when the session ends and/or the user completes his or her review of the patient information, changes made to the information by the user are uploaded back to the respective information system(s) to make sure that the information is up-to-date at the different information system(s). The information imported by the local system for the queried patient (e.g., the local information) can then be destroyed and/or erased from the local system. In this manner, examples disclosed and described herein reduce or minimize the size of local storage devices to present information consolidated from different information systems to the user.

Although the methods, systems and machine readable storage media disclosed herein are described with regard to healthcare applications, it is to be understood that the present methods, systems and machine readable storage media can also be used to import information from different information systems to a local system for presentation without importing the information for permanent storage in the local system.

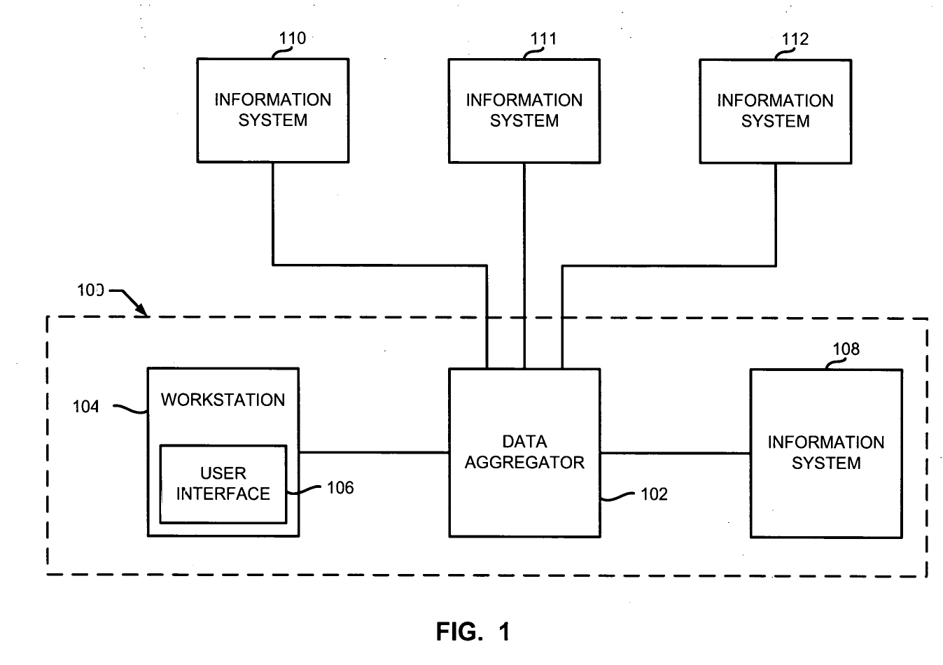

Turning now to the figures, FIG. 1 shows a block diagram of an example healthcare system 100 having an example data aggregation system 102, which, in some examples, enables a practitioner (sometimes referred to herein as a “user”) such as a nurse, a technician, a physician, a radiologist, etc. to import information from different information systems for presentation at a local system without importing the information for permanent storage at the local system, as described in further detail below. The healthcare system 100 of the illustrated example includes the data aggregation system 102, a workstation 104 and an example information system 108.

In some examples, the data aggregation system 102, the workstation 104 and the information system 108 are housed in a healthcare facility and/or locally archived. In some other examples, the data aggregation system 102, the workstation 104 and/or the information system 108 can be housed in one or more other suitable locations. For example, the data aggregation system 102, the workstation 104 and the information system 108 may be housed in a first healthcare facility while example information systems 110-112 may be housed in a second healthcare facility. In some examples, one or more of the data aggregation system 102, the workstation 104 and/or the information systems 108, 110-112 can be implemented remotely via a thin client and/or downloadable software solution. Furthermore, one or more components of the healthcare system 100 can be combined and/or implemented together. For example, the data aggregation system 102 can be integrated with the workstation 104. Information (e.g., scheduling, test results, observations, diagnosis, etc.) can be entered into the information systems 108, 110-112 by healthcare practitioners (e.g., nurses, technicians, radiologists, and/or registrars) before and/or after patient examination.

The example data aggregation system 102 of FIG. 1 enables importing patient information (e.g., patient demographics, images, medical data, medical reports, administrative information and/or other clinical information) from different information systems at a local system and reviewing the imported patient information via the local system without importing the patient information for permanent storage at the local system. The example data aggregation system 102 can be connected to any instrument (e.g., equipment, medical device, sensor, etc.) to receive, record, store and/or modify information associated with patient information. In some examples, the data aggregation system 102 includes a user interface and/or a workstation for presenting and/or interacting with the patient information. In other examples, the data aggregation system 102 can be accessed by the example workstation 104, described in detail below. In some examples, the data aggregation system 102 is combined and/or implemented with one or more of the other components of the healthcare system 100 (e.g., the data aggregation system 102 is combined with the workstation 104).

In the illustrated example of FIG. 1, the example data aggregation system 102 imports information associated with patient information from the example information systems 108, 110-112. In some examples, the data aggregation system 102 includes interface connections, implemented by, for example, a Wide Area Network (WAN) such as a private network or the Internet, to facilitate communication among the information systems 108, 110-112. Accordingly, the example data aggregation system 102 can include one or more communication components such as an Ethernet device, an asynchronous transfer mode (ATM) device, an 802.11 device, a digital subscriber line (DSL) model, a cable modem, a cellular modem, etc. In turn, the example data aggregation system 102 can communicate with the example workstation 104 via a network implemented at a plurality of locations (e.g., a hospital, clinic, doctor's office, other medical office, or terminal, etc.). The network can be implemented by, for example, the Internet, an Intranet, a private network, a wired and/or wireless Local Area Network (LAN), and/or a wired and/or wireless WAN. The example data aggregation system 102 can then transmit the imported patient information to the example workstation 104 for review by the practitioner.

In the illustrated example of FIG. 1, the healthcare system 100 includes the example workstation 104 to enable viewing and easily retrieving patient information at a later time via, for example, their common identification element, such as a patient name or medical record number. The example workstation 104 of FIG. 1 can be any equipment (e.g., a personal computer) capable of executing software that permits electronic data (e.g., medical reports) and/or electronic medical images (e.g., x-rays, ultrasounds, MRI scans, etc.) to be acquired, stored, processed or transmitted for viewing and operation. The example workstation 104 of the illustrated example receives commands and/or other input from a user (e.g., a healthcare practitioner) via, for example, a keyboard, mouse, track ball, microphone, etc. The example workstation 104 can implement an example user interface 106 (e.g., a graphical user interface) to enable a healthcare practitioner to interact with the healthcare system 100.

In the illustrated example of FIG. 1, the example information systems 108, 110-112 store hospital information (e.g., medical information such as clinical reports, patient information, administrative information received from, for example, personnel at a hospital, clinic and/or a physician's office), radiology information (e.g., radiology reports, messages, warnings, alerts, patient scheduling information, patient demographics data, patient tracking information, and/or physician and patient status monitors), digital images (e.g., medical images and data such as x-rays, scans, three-dimensional renderings, digital version of fetal heart monitor strips, etc.), etc. The information stored in the information systems 108, 110-112 can be stored using different formats. For example, medical images and data may be stored in a picture archiving and communication system (PACS) using the Digital Imaging and Communications in Medicine (DICOM) format, information stored in a radiology information system (RIS) may be formatted according to the HL-7 (Health Level Seven) clinical communication protocol, hospital information may be formatted into Structured Query Language (SQL) or standard text before being stored in a hospital information system (HIS), and/or other information systems may store information using similar formats used in present and/or future data storage formats.

In the illustrated example of FIG. 1, the example information system 108 communicates with the example data aggregation system 102 via a local area network (LAN) such as a private network, an intranet, etc. within a healthcare environment (e.g., the healthcare system 100). Accordingly, the example information system 108 may sometimes be referred to herein as a local information system. In the illustrated example, the data aggregation system 102 and/or the workstation 104 of FIG. 1 have direct access to information stored in the local information system 108. In contrast, the example information systems 110-112 communicate with the example healthcare system 100 via an external network. Accordingly, the example information systems 110-112 may sometimes be referred to herein as foreign information systems. In the illustrated example, the data aggregation system 102 and/or the workstation 104 of FIG. 1 have indirect access to information stored in the foreign information systems 110-112. For example, the foreign information systems 110-112 can involve a separate login process prior to the data aggregation system 102 and/or the workstation 104 accessing the foreign stored information. In some examples, the foreign information systems 110-112 can store information in a format different than the format used within the healthcare system 100, include different definitions for optional versus required fields, etc.

In the illustrated example of FIG. 1, the data aggregation system 102 is located separately in the healthcare system 100. In some other examples, the data aggregation system 102 is located in a component of the healthcare system 100. In some examples, the data aggregation system 102 is connected directly to the workstation 104 and the user interface 106. In some examples, the workstation 104 and the user interface 106 are incorporated directly into the data aggregation system 102.

The example data aggregation system 102 of FIG. 1 generates a local record when a request for patient information is received during a user session, and imports information regarding the patient from the information systems 108, 110-112 without first transforming the patient information to a common format. Further, the example data aggregation system 102 facilitates presenting the local information to the user and tracks changes made to the patient information during the user session. When the current review (e.g., the review of the local information) is complete (e.g., when the user sessions ends or the user closes the local record), the example data aggregation system 102 pushes any changes made to the local information to the source information system and destroys the information imported by the data aggregation system 102 (e.g., the information imported from the information systems 108, 110-112), thereby minimizing the size of local storage devices needed to review patient information located at different (e.g., local and/or foreign) information systems.

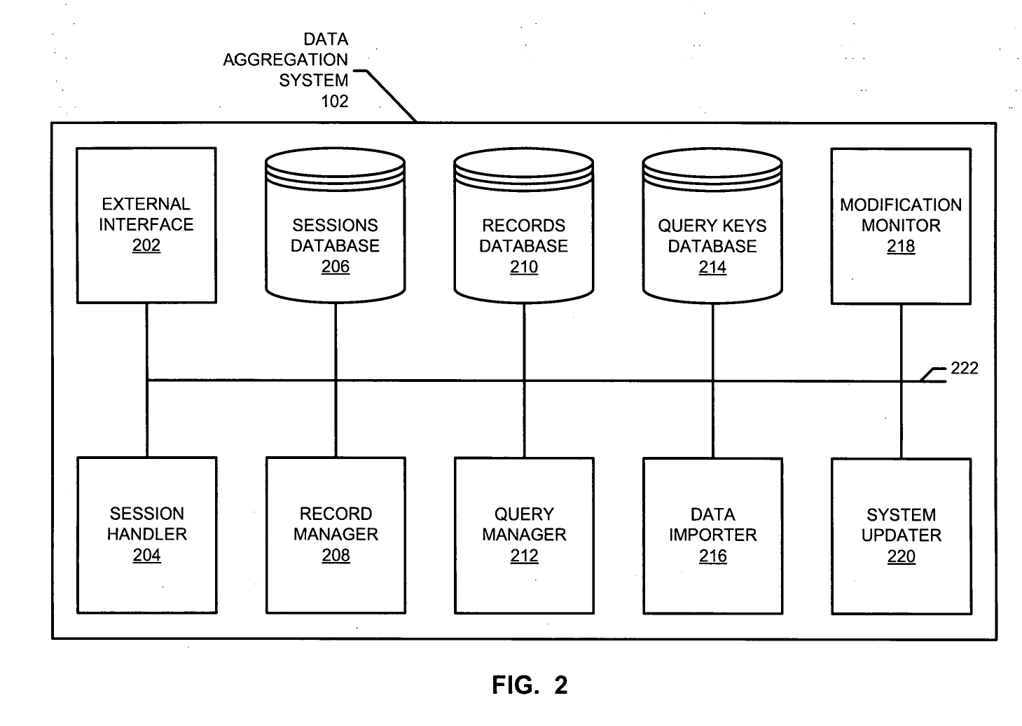

FIG. 2 is a block diagram of an example implementation of the example data aggregation system 102 of FIG. 1. In the illustrated example of FIG. 2, the data aggregation system 102 enables a practitioner to view patient information that is imported from different (e.g., local and/or foreign) information systems at a local system without importing the patient information for permanent storage at the local system. When the example data aggregation system 102 receives a request for information for a patient, the data aggregation system 102 identifies a query key(s) that corresponds to the patient at different information systems. The example data aggregation system 102 can then query the different information systems for the requested information and present the imported information at the local system without transforming the imported information. The data aggregation system 102 of FIG. 2 can have direct and/or indirect access to the information stored in the different information systems. For example, the data aggregation system 102 can directly import information stored in a local information system (e.g., the example information system 108 of FIG. 1). In other examples, the data aggregation system 102 first logs in (e.g., connects) to foreign information systems (e.g., the example information systems 110-112 of FIG. 1) prior to importing information from the foreign information systems. The data aggregation system 102 can then present the imported information from the different information systems to the user, and track any changes the user makes to the imported information. In some examples, the data aggregation system 102 varies the information imported and/or displayed to the user based on a permission (or clearance) level associated with the user. When the session ends, the example data aggregation system 102 updates the information at the source information system(s) with the changes made by the user and destroys the information imported at the local system.

The example data aggregation system 102 of FIG. 2 includes an example external interface 202, an example session handler 204, an example sessions database 206, an example record manager 208, an example records database 210, an example query manager 212, an example query keys database 214, an example data importer 216, an example modification monitor 218 and an example system updater 220. In the illustrated example of FIG. 2, the data aggregation system 102 includes the example external interface 202 to facilitate exchanging communications with workstations (e.g., the example workstation 104 of FIG. 1) and/or information systems (e.g., the example information systems 108, 110-112 of FIG. 1). For example, the external interface 202 can receive user input from one or more of the example workstations 104 and/or the example user interface 106 of FIG. 1. In some examples, the external interface 202 receives information directly from the example information systems 108, 110-112. In some examples, the data aggregation system 102 presents information with the workstation 104 and/or the example user interface 106 via the external interface 202. The example external interface 202 of FIG. 2 can communicate with any display device such as a computer screen, an image viewer and/or other display device.

In the illustrated example of FIG. 2, the data aggregation system 102 includes the example session handler 204 to manage user access to patient information. For example, a user may attempt to initiate a user session via the example workstation 104 and/or the example user interface 106. In some such examples, the session handler 204 authenticates the user via login credentials stored in a data structure such as a table, a list, a document, etc., in the example sessions database 206. For example, the session handler 204 can use a lookup table in the sessions database 206 to check whether login information provided by a user matches login credentials (e.g., a user name and password pair) stored in the lookup table. In some examples, when the user is authenticated, the example session handler 204 outputs a message indicating that the user is authorized to access the data aggregation system 102.

In the illustrated example, the session handler 204 of FIG. 2 initiates communication with the different information systems connected to the data aggregation system 102 when the user is authorized. For example, via the external interface 202, the session handler 204 can connect to local information systems (e.g., the information system 108) available to the data aggregation system 102. The example session handler 204 can also attempt to connect to foreign information systems (e.g., the information systems 110-112) available to the data aggregation system 102. For example, the session handler 204 can use login credentials stored in a data structure in the example sessions database 206 to connect the user to the different information systems 108, 110-112. As a result, when the user desires information regarding a certain patient, the user does not have to manually login to each of the different foreign information systems 110-112 to access the information. Rather, the data aggregation system 102 automatically connects the user to the different foreign information systems, thereby making the information stored in each of the different information systems 108, 110-112 accessible to the practitioner.

In some examples, the session handler 204 of FIG. 2 associates permission levels with a user when the user is an authenticated user. As used herein, permission levels (sometimes referred to herein as “security levels” or “clearance levels”) define business rules and/or configuration settings applicable to the associated user. For example, a permission level associated with a first user (e.g., a nurse or a technician) may permit demographics information to be imported by the data aggregation system 102 and prevent the data aggregation system 102 from importing medical images. Further, a first portion of the demographics information may be masked while a second portion of the demographics information is presented to the first user. A permission level associated with a second user (e.g., a radiologist) may permit the demographics information and the medical images to be imported by the data aggregation system 102 and the first portion of the demographics information may be masked while the medical images and the second portion of the demographics information is presented to the second user. A permission level associated with a third user (e.g., a registrar) may import the demographics information for the patient and prevent importing the medical images, and present the first portion and the second portion of the demographics. As used herein, information that is masked is hidden from the user via, for example, replacing characters with dummy characters (e.g., an asterisks (*), the letter “X”, a blank space, etc.). In some examples, information such as a social security number may be partially masked (e.g., the first five characters of the social security number are replaced with dummy characters) and partially presented (e.g., the last four characters of the social security number are presented).

In the illustrated example, the session handler 204 of FIG. 2 obtains the associated permission levels from the sessions database 206. For example, the permission levels may be stored in the sessions database 206 as a data structure such as a table (e.g., a lookup table), a list, a document, etc. In some examples, the permission levels may be assigned based on the different practitioner types (e.g., a nurse, a technician, a radiologist, etc.).

The example session handler 204 of FIG. 2 can also initiate an information termination process when session ending instructions are received from, for example, the user via the workstation 104 and/or the user interface 106. For example, the session handler 204 can cause the destruction of the information imported from the different information systems 108, 110-112 by, for example, writing over the information, deleting links to the information, etc.

In the illustrated example of FIG. 2, the data aggregation system 102 includes the example record manager 208 to manage patient information presented to the user via the workstation 104 and/or the user interface 106. For example, when initiated by, for example, a message received from the session handler 204, the record manager 208 can create a local record in the records database 210 for a patient. For example, information for a patient can be imported to a data table in the records database 210. The example records database 208 stores information imported from the different information systems for the current record. That is, a patient's complete history from the different information systems is available for review by the user via the data aggregations system 102. In the illustrated example of FIG. 2, the records database 208 stores information imported from local and/or foreign information systems in the format that the information is received. That is, information from the information systems 108, 110-112 by the data aggregation system 102 is not modified (e.g., reformatted, transformed, etc.) prior to being imported to the records database 210.

The example record manager 208 of FIG. 2 can then control the information imported to the records database 210 and/or presented to the practitioner based on the permissions level associated with the current session user. In some examples, the record manager 208 uses the permission levels obtained by the session handler 204 to determine how much of the patient information the user is permitted to view. For example, based on the session user's associated permission level, the record manager 208 can partially import the information associated with a patient from the information system(s) (e.g., import demographics information but not medical exams for a patient), mask information when it is imported to the records database 210 (e.g., when a social security number is imported from an information system, the first five of the nine characters are replaced with dummy characters in the records database 210), and/or mask the information when it is presented to the user (e.g., the nine characters of the social security number are imported to the records database 210, but presented as masked information until the user selects the masked information). For example, when a nurse accesses a patient's information during, for example, the patient's intake, the nurse may neither need access to any medical images associated with the patient nor the complete social security number of the patient. Thus, the example record manager 208 of FIG. 2 can decide not to import medical images from the different information systems, and decide to import only a portion of the social security number and to mask the remainder of the social security number to, for example, confirm a patient's identity. In some other examples, when a radiologist accesses a patient's information during an exam, the record manager 208 can decide to import the medical images, and decide to import only a portion of the social security and to mask the remainder of the social security number. In some other examples, when a registrar accesses a patient's information, the record manager 208 can decide to import the complete social security number, but mask the social security number during presentation to, for example, prevent passersby to accidentally see a patient's social security number. The example record manager 208 can then present the complete social security number when the registrar, for example, selects the social security field, hovers an input device (e.g., a mouse) over the masked social security number. The example record manager 208 of FIG. 2 can then cause the user interface 106, via the external interface 202, to display the permitted information from the records database 210 accordingly.

The example record manager 208 of FIG. 2 can also terminate the information imported into the records database 210 when an information termination instruction is received via the workstation 104 and/or the user interface 106. For example, the record manager 208 can destroy the imported information in the records database 210 (e.g., the information imported from the information systems 108, 110-112) by, for example, writing over the information, deleting links to the information in the records database 210, etc.

In the illustrated example of FIG. 2, the data aggregation system 102 includes the example query manager 212 to manage patient queries received from the practitioner via, for example, the workstation 104 and/or the user interface 106. For example, a practitioner may desire to review medical information for a certain patient. In some such examples, the practitioner may enter a patient identifier such as a patient name via the workstation 104 and/or the user interface 106. The example query manager 212 receives the patient identifier from the external interface 202 and queries the query keys database 214 for links or indicators (e.g., medical record numbers, patient names, etc.) to query keys associated with the patient. As described above, different information systems can store information using different formats. Further, different information systems can index data entries using different query keys such as different medical record numbers. For example, the information system 108 may index patient information by query keys defined by patient first names followed by patient last names (“SUZY_SMITH”), while the information system 111 may use query keys defined by patient last names followed by patient first names (“SMITH_SUZY”). The example global identifier database 214 enables the query manager 212 to identify the associated query key for each of the respective information systems that correspond to the patient identifier. That is, when queried with, for example, a patient's name (“Suzy Smith”), the query keys database 214 may return a first query key (“SUZY_SMITH”) for use at the information system 108, and a second query key (“SMITH_SUZY”) for use at the information system 111. In some examples, a patient can be indexed in different information systems with different names. For example, the query keys database 214 may return the third query key (“SUZY_JOHNSON”) for use at the information system 112 when the query keys database 214 is queried with the patient identifier (“Suzy Smith”). In some other examples, the query keys database 214 may return a single query key for use in different information systems. In some examples, the query manager 212 and/or the query keys database 214 may be implemented via a Patient Identifier Cross Referencing (PIX) system.

In the illustrated example of FIG. 2, the data aggregation system 102 includes the example data importer 216 to import (sometimes referred to herein as “extract,” “retrieve” or “pull”) patient information associated with the patient from the different information systems (e.g., the example information systems 108, 110-112). For example, the data importer 216 can use the list of query keys returned by the query keys database 214 to query the different information systems 108, 110-112. Thus, for example, to collect information from the information systems 108, 110-112 for the patient (“Suzy Smith”), the query keys database 214 may return the first query key (“SUZY_SMITH”) to query the information system 108, the second query key (“SMITH_SUZY”) to query the information system 111, and the third query key (“SUZY_JOHNSON”) to query the information systems 110, 112. The example data importer 216 of FIG. 2 imports the information to the example records database 210. In some examples, the data importer 216 also logs the source information system from where the information was imported and/or a timestamp identifying when the information was imported by the data aggregation system 102. For example, the data importer 216 can append entries for information imported from the information system 108 with an identifier for the information system (e.g., “HIS”), and append entries for information imported from the information 111 system with an identifier for the information system (e.g., “PACS”). In some examples, the data importer 216 appends a timestamp identifying when information was imported. For example, the data importer 216 may include a clock and/or calendar to identify a time (e.g., 12:05 p.m. Central Standard Time (CST)) and a date (e.g., Jan. 1, 2013) when the information is imported by the data aggregation system 102.

In some examples, the data importer 216 periodically and/or aperiodically re-queries the different information systems for information related to the patient identifier. For example, the data importer 216 can check the timestamp associated with the information in the records database 210 to identify information in the records database 210 that has not been updated in a predetermined amount of time or may no longer be valid. For example, the data importer 216 may check timestamps associated with information entries in the records database 210 to determine if any of the imported information has not been updated (or verified) within a threshold duration (e.g., in a pre-determined amount of time) and, thus, have stale information (e.g., outdated information or information that may no longer be valid). In some examples, information becomes stale when a subsequent update has not been performed for the information in a pre-determined amount of time. In some examples, the threshold duration varies based on the type of information. For example, demographics information may change less frequently than medical images and, thus, the threshold duration for demographics information may be longer relative to the threshold duration for medical images. In the illustrated example of FIG. 2, when the data importer 216 determines information to be stale, the data importer 216 re-queries the source information system for the information to import new (e.g., fresh) information. In some examples, if the new information is different than the previously imported information, then the data importer 216 re-queries the different information systems 108, 110-112 to check if any new information is available. In some other examples, the data importer 216 can query the different information systems whenever a change in information stored in one of the information systems is detected. For example, the data importer 216 can query the information systems 108, 111, 112 after detecting new information corresponding to the patient at the information system 110. As a result, the information imported to the records database 210 is accurate and the user is reviewing up-to-date patient information.

In the illustrated example of FIG. 2, the data aggregation system 102 includes the example modification monitor 218 to monitor for modifications to the local information imported to the records database 210. For example, a user may change the value of information displayed via the workstation 104 and/or the user interface 106. For example, the user may select a patient's weight field, via an input device such as a keyboard or mouse, and change the value of the patient's weight via the input device. When the example modification monitor 218 detects user input and determines that the user input corresponds to a change in the field value of an information entry, the modification monitor 218 sets an update flag associated with the modified information entry in the records database 210 (e.g., toggles the update flag to a 1, true, on, yes; etc.). In some examples, the modification monitor 218 can maintain a record of previous information values during the session and check whether a change to a field value modifies the field value to the original field value of the information entry when the information was imported. For example, the data importer 216 can import a patient's weight value (“145”) to the records database 210. A user may review the information and change the patient's weight (e.g., “156”), thereby resulting in the modification monitor 218 setting the update flag associated with the patient's weight field in the records database 210. The user may then change the value of the patient's weight back to the original value (“145”). In some such examples, the modification monitor 218 can determine that the current weight value (“145”) is the same as the originally imported weight value (“145”), and reset the update flag (e.g., toggle the update flag to a 0, false, off, no, etc.). In some other examples, the modification monitor 218 can set the update flag whenever user input is received for an information field, regardless of whether a change in value is detected. In some such examples, the modification monitor 218 can maintain the set update flag even when the practitioner changes the weight value back to the originally imported weight value.

In the illustrated example of FIG. 2, the data aggregation system 102 includes the example system updater 220 to update information stored in the different information systems based on modifications made by the user to the local information. For example, the system updater 220 can parse the records database 210 and identify entries with update flags that were set by the modification monitor 218 (e.g., the modification monitor 218 detected a change in field value of the associated information entry). The example system updater 220 can then push the updated values to the respective source information systems. For example, the system updater 220 can update the information imported by the data aggregation system 102 from the information systems 108, 110-112. In some examples, the system updater 220 pushes the values for all imported information to the respective source information systems, regardless of whether any information values were updated.

In the illustrated example of FIG. 2, the external interface 202, the session handler 204, the sessions database 206, the record manager 208, the records database 210, the query manager 212, the query keys database 214, the data importer 216, the modification monitor 218 and the system updater 220 are in communication with each other via an example data bus 222. However, in other examples, the external interface 202, the session handler 204, the sessions database 206, the record manager 208, the records database 210, the query manager 212, the query keys database 214, the data importer 216, the modification monitor 218 and/or the system updater 220 can be located offsite or implemented in another device such as, for example, one or more of the components of the healthcare system 100 shown and described in FIG. 1.

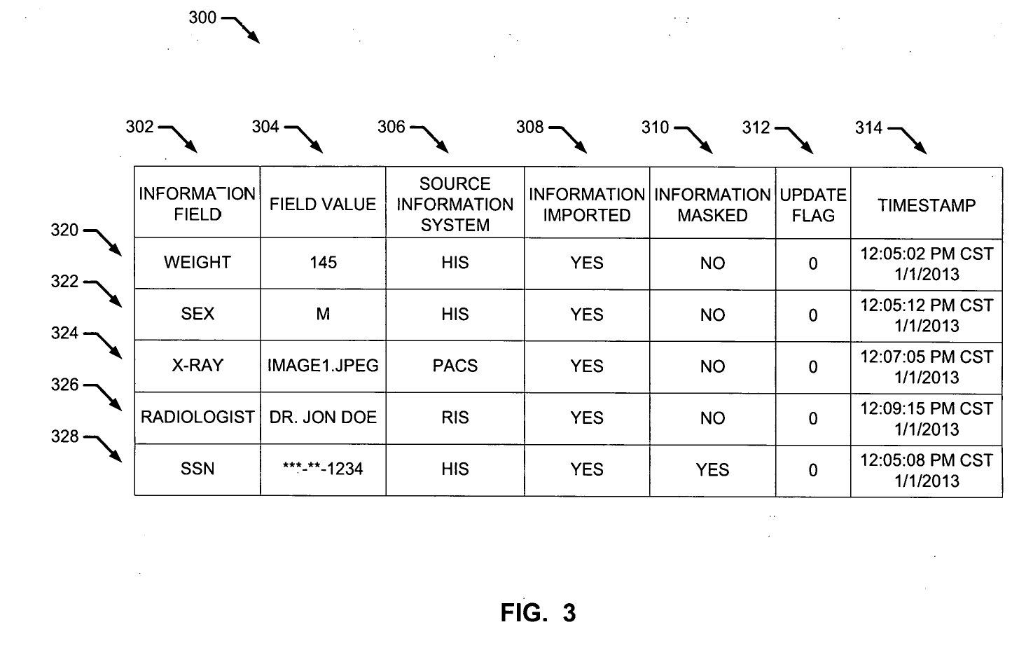

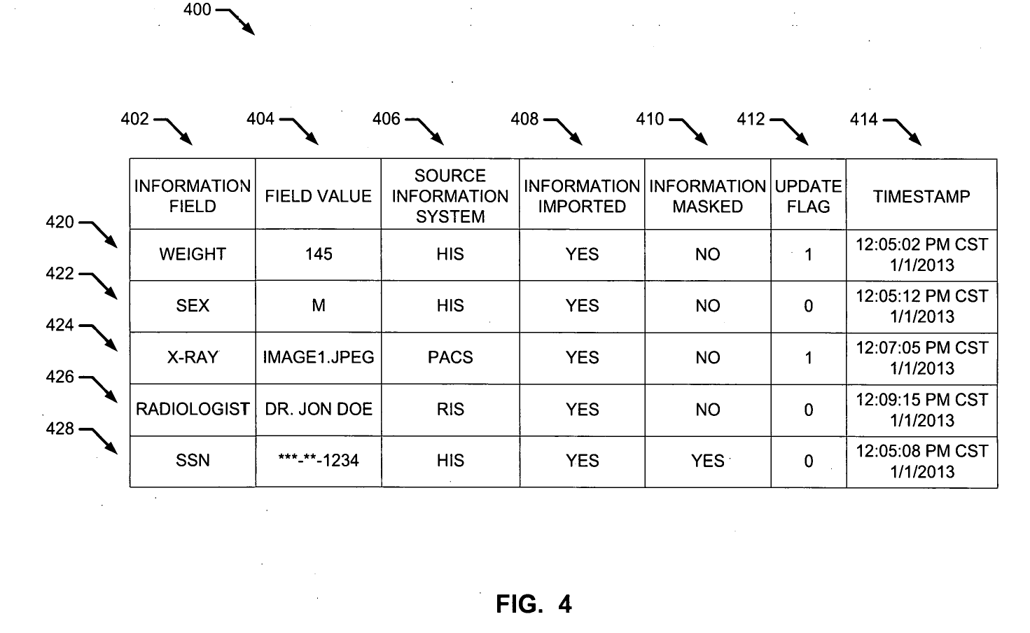

FIGS. 3 and 4 illustrate example data tables 300, 400 representing a first and second state, respectively, of information imported by the example data aggregation system 102 of FIGS. 1 and/or 2 to the records database 210 of FIG. 2 for a requested patient. In the illustrated example of FIG. 3, the data table 300 represents a first state of the local information in the example records database 210 after the data aggregation system 102 imports information from different information systems. The example data table 300 identifies an information field 302, a field value 304, a source information system field 306, an information imported field 308, an information masked field 310, an update flag field 312, and a timestamp field 314. The information field 302 indicates the type of information imported (e.g., weight information, sex information, etc.). The field value 304 indicates the value of the corresponding information field 302 (e.g., “145,” “M,” etc.). The source information system field 306 indicates the source information system from which the information (e.g., the field value 304 corresponding to the information field 302) was pulled. The information imported field 308 indicates whether the value field 304 corresponding to the information field 302 is imported to the records database 210. The information masked field 310 indicates whether the information presented to the user is to be masked (e.g., whether the practitioner is permitted to view the corresponding field value 304). The update flag field 312 indicates whether the field value 304 of the corresponding information field 302 has been changed since the information was imported from the source information system 306. The timestamp field 314 indicates the date and/or time when the information entry was imported to the records database 210.

In operation, the example data importer 216 imports information (e.g., the field value 304 corresponding to the information field 302) for a patient from different information systems (e.g., the example information systems 108, 110-112 of FIG. 1) when initiated by the example query manager 212. The data importer 216 then stores the imported information in the data table 300 of the example records database 210. The example data importer 216 also populates the source information system field 306 based on the information system that the data importer 216 imported the corresponding information and the timestamp 314 based on the date and/or time the information was imported. For example, the information entry 320 of the data table 300 indicates the patient's weight (“145”), the information system from where the weight value was imported (“HIS”) and the timestamp the weight value was imported.

As described above in connection with the example record manager 208, when initiated, the record manager 208 controls the information imported to the records database 210 and/or presented to the user based on, for example, permission levels associated with the logged-in practitioner (e.g., the session user). In the illustrated example of FIG. 3, the information imported field 308 of the information entries 320, 322, 324, 326, 328 indicate that the corresponding information was imported from the source information system. The information masked field 310 of the information entries 320, 322, 324, 326 indicate that the corresponding information is not masked (e.g., is presented to the user). Thus, for example, when a radiologist is reviewing the patient information imported to the data table 300, the workstation 104 and/or the user interface 106 presents the patient's weight (“145”), the patient's sex (“M”), an x-ray taken of the patient (“Image1.JPEG”) and the radiologist who interpreted the x-ray (“Dr. Jon Doe”). However, the record manager 208 masks (e.g., hides) information regarding the social security number of the patient (“***-**-1234”) by setting the information masked field 310 (e.g., toggling the value of the information masked field 310) of the information entry 328. Thus, the radiologist is presented with the masked social security number (“***-**-1234”).

The data table 300 also includes the update flag field 312 to indicate whether the user modified the information value since the information was imported from the source information system 306. For example, the update flag field 312 of the data table 300 indicates that the user has not changed the field values 304 for each of the information entries 320, 322, 324, 326, 328, and, thus, the value of each information entry is the same as the value that was imported from the respective source information systems.

As discussed above, the information imported to the records database 210 and/or presented to the user can be varied based on the permission levels associated with the user. Thus, for example, when a nurse is accessing information for a patient, the record manager 208 resets (e.g., toggles the value to 0, false, off, no, etc.) the information imported field 308 of the information entry 324 so that medical images for the patient are not imported from information systems to the records database 208. In some other examples, when a registrar accesses information for a patient, the record manager 208 sets (e.g., toggles the value to 1, true, on, yes, etc.) the information imported field 308 of the information entry 328 so that the social security number is imported and resets (e.g., toggles the value to 0, false, off, no, etc.) the information masked field 310 of the information entry 328 so that the social security number is presented to the registrar (e.g., the social security number is unmasked). In some examples, information may be imported when selected by the user. For example, the record manager 208 can prevent the data importer 216 from initially importing the social security number, but then permit the data importer 216 to import the social security number when the registrar desires (or wishes) to see the complete social security number value.

In the illustrated example of FIG. 4, the data table 400 represents a second state of the local information in the example records database 210 after information is imported from the different information systems by the example data importer 216. The example data table 400 identifies an information field 402, a field value 404, a source information system field 406, an information imported field 408, an information masked field 410, an update flag field 412 and a timestamp field 414. The information field 402 indicates the type of information imported (e.g., weight information, sex information, etc.). The field value 404 indicates the value of the corresponding information field 402. The source information system field 406 indicates the source information system from which the information (e.g., the field value 404 corresponding to the information field 402) was pulled. The information imported field 408 indicates whether the value field 404 corresponding to the information field 402 is imported to the records database 210. The update flag field 312 indicates whether the field value 304 of the corresponding information field 302 has been changed since the information was imported from the source information system 306. The information masked field 410 indicates whether the information presented to the user is to be masked (e.g., whether the user is permitted to view the corresponding field value 404). The update flag field 412 indicates whether the field value 404 of the corresponding information field 402 has been changed since the information was imported from the source information system 406. The timestamp field 414 indicates the date and/or time when the information entry was imported to the records database 210.

In operation, the example modification monitor 218 monitors user input and determines whether the user input modifies the field value 404 of a corresponding information entry (e.g., the information entries 420, 422, 424, 426, 428). If the modification monitor 218 determines that the user modified the local information (e.g., a field value 404), the example modification monitor 218 sets the update flag field 412 of the corresponding information entry (e.g., toggles the value of the update flag field 412). In the illustrated example, the update flag field 412 of the information entries 420, 424 indicate that the user modified the field value 404 of the corresponding information fields 402. For example, the update flag field 412 of the information entry 420 is set and the corresponding field value 404 indicates the new information (e.g., the updated weight (“156”) of the patient). Likewise, the update flag field 412 of the information entry 424 is set and indicates that the user modified the field value 404 of the x-ray information field 402. In the illustrated example, the user replaced the x-ray image (e.g., changed the original x-ray image (“Image1.JPEG”) to a new x-ray image (“Image3.JPEG”). In some examples, replacing a medical image may include providing a new medical image, modifying an imported medical image (e.g., adding annotations to the imported medical image and saving the modified medical image), etc.

While an example manner of implementing the data aggregation system 102 of FIG. 1 is illustrated in FIG. 2, one or more of the elements, processes and/or devices illustrated in FIG. 2 may be combined, divided, re-arranged, omitted, eliminated and/or implemented in any other way. Further, the example external interface 202, the example session handler 204, the example sessions database 206, the example record manager 208, the example records database 210, the example query manager 212, the example query keys database 214, the example data importer 216, the example modification monitor 218, the example system updater 220 and/or, more generally, the example data aggregation system 102 of FIG. 1 may be implemented by hardware, software, firmware and/or any combination of hardware, software and/or firmware. Thus, for example, any of the example external interface 202, the example session handler 204, the example sessions database 206, the example record manager 208, the example records database 210, the example query manager 212, the example query keys database 214, the example data importer 216, the example modification monitor 218, the example system updater 220 and/or, more generally, the example data aggregation system 102 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example external interface 202, the example session handler 204, the example sessions database 206, the example record manager 208, the example records database 210, the example query manager 212, the example query keys database 214, the example data importer 216, the example modification monitor 218 and/or the example system updater 220 is/are hereby expressly defined to include a tangible computer readable storage device or storage disk such as a memory, a digital versatile disk (DVD), a compact disk (CD), a Blu-ray disk, etc. storing the software and/or firmware. Further still, the data aggregation system 102 of FIG. 1 may include one or more elements, processes and/or devices in addition to, or instead of, those illustrated in FIG. 2, and/or may include more than one of any or all of the illustrated elements, processes and devices.

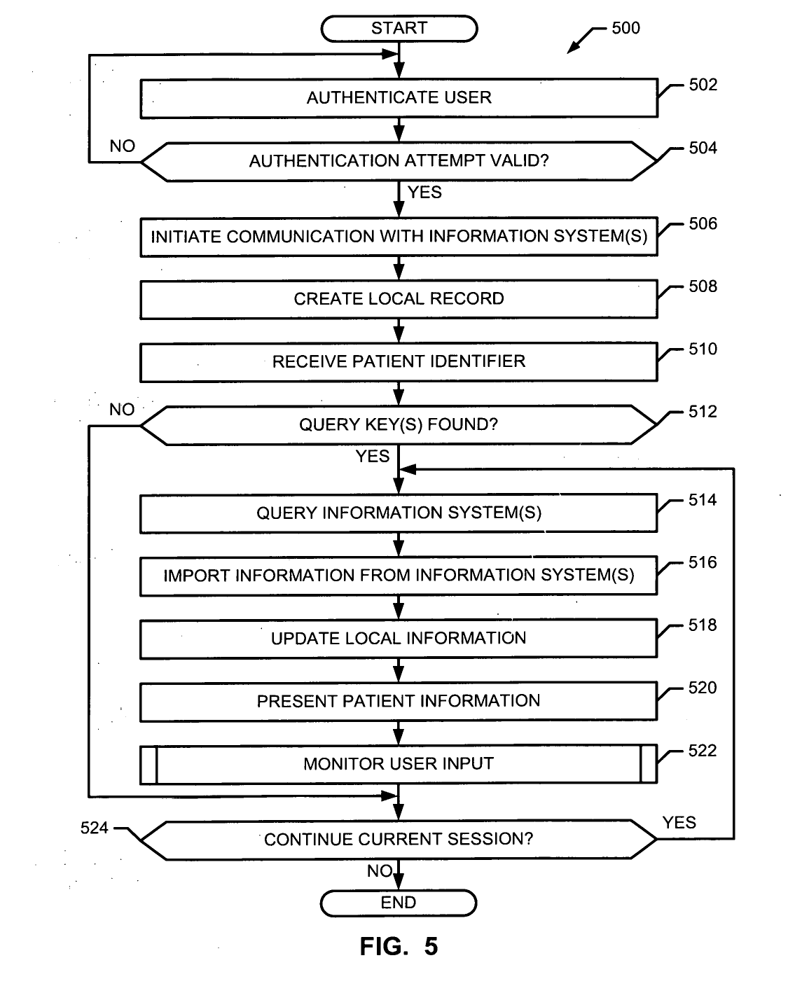

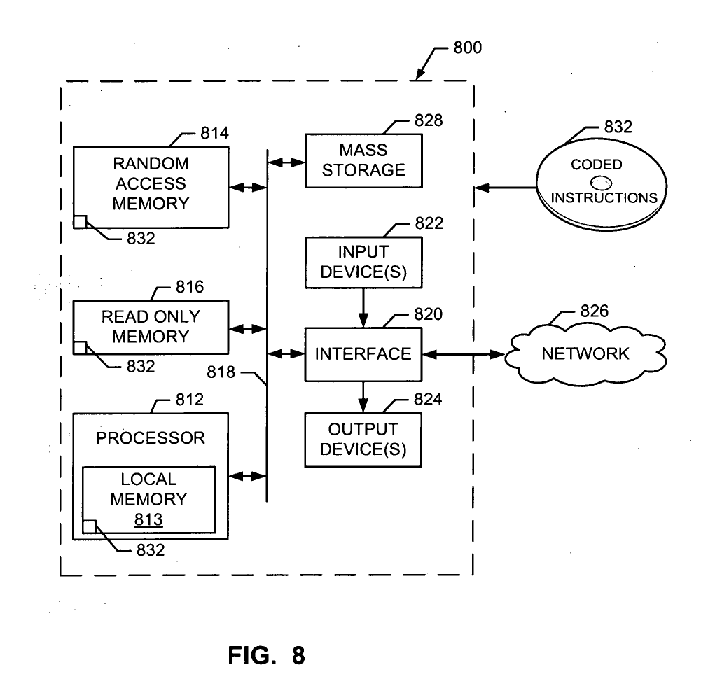

Flowcharts representative of example machine readable instructions for implementing the data aggregation system 102 of FIGS. 1 and/or 2 are shown in FIGS. 5-7. In these examples, the machine readable instructions comprise a program for execution by a processor such as the processor 812 shown in the example processor platform 800 discussed below in connection with FIG. 8. The program may be embodied in software stored on a tangible computer readable storage medium such as a CD-ROM, a floppy disk, a hard drive, a digital versatile disk (DVD), a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowcharts illustrated in FIGS. 5-7, many other methods of implementing the example data aggregation system 102 may alternatively be used. For example, the order of execution of the blocks may be changed, and/or some of the blocks described may be changed, eliminated, or combined.

As mentioned above, the example processes of FIGS. 5-7 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5-7 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The example program 500 of FIG. 5 initiates the example data aggregation system 102 of FIGS. 1 and/or 2. The example program 500 of FIG. 5 begins at block 502 when the data aggregation system 102 authenticates a user. For example, a healthcare practitioner (e.g., a nurse, a technician, a radiologist, etc.) may attempt to initiate a user session via the example workstation 104 and/or the example user interface 106 (FIG. 1). In some such examples, the example session handler 204 (FIG. 2) compares login information entered by the user, and received via the example external interface 202 (FIG. 2), against login credentials (e.g., a user name and password pair) stored in the example sessions database 206 (FIG. 2). If, at block 504, the example session handler 204 determines that the authentication failed (e.g., the login information does not match login credentials stored in the example sessions database 206), then control returns to block 502 to re-authenticate the practitioner. In some examples, after a preset number of failed (e.g., incorrect) attempts, the example session handler 204 can block (or prevent) the user from accessing the data aggregation system 102 and/or the workstation 104.

Otherwise, if, at block 504, the session handler 204 determines that the authentication is valid (e.g., the login information entered by the practitioner matches login credentials stored in the sessions database 206), then, at block 506, the session handler 204 initiates communication with the information system(s) connected to the data aggregation system 102. For example, the session handler 204 can connect to the local information systems (e.g., the example information system 108 of FIG. 1) available to the data aggregation system 102. The example session handler 204 can also attempt to connect to the foreign information systems (e.g., the information systems 110-112 of FIG. 1) available to the data aggregation system 102. For example, the session handler 204 can use login credentials stored in a data structure in the sessions database 206 to connect the user to the foreign information systems during the user session. Thus, the data aggregation system 102 automatically connects the user to the different information systems, including local information systems and/or foreign information systems, thereby making the information stored in each of the different information systems accessible to the user.

At block 508, the data aggregation system 102 creates a local record in the example records database 210 (FIG. 2). For example, the session handler 204 can cause the example record manager 208 (FIG. 2) to create a local record (e.g., the example data tables 300, 400 of FIGS. 3 and 4, respectively) in the example records database 210.

At block 510, the example data aggregation system 102 receives a request for patient information via a patient identifier. For example, when a user desires to review information for a patient, the user may enter, via an input device, the workstation 104 and/or the user interface 106, an identifier for the patient such as the patient's name, a medical record number, etc. The example external interface 202 receives the patient identifier and passes the patient identifier to the example query manager 212 (FIG. 2). At block 512, the example query manager 212 identifies query keys that correspond to the patient identifier via the query keys database 214. For example, the query manager 212 can use a lookup table stored in the query keys database 214 to determine query key(s) for each of the respective different information systems connected to the data aggregation system 102. If, at block 512, the query manager 212 does not find query keys in the query keys database 214 that correspond to the patient identifier, then control advances to block 524 to determine whether to continue the current session. In some examples, if the query manager 212 does not find query keys, the query manager 212 uses the patient identifier as the query key for the different information systems.

Otherwise, if at block 512, the example query manager 212 does find query keys that correspond to the patient identifier, then, at block 514, the data aggregation system 102 queries the available information system(s) for information relating to the patient. For example, the query manager 212 can use the identified query keys to query the different information systems in communication with the data aggregation system 102 (e.g., via successful communication initiated by the session handler 204). At block 516, the example data aggregation system 102 imports information corresponding to the patient identifier from the available information system(s). For example, the data importer 216 (FIG. 2) imports the information identified by the query manager 212. At block 518, the data aggregation system 102 updates the information in the records database 210. For example, the record manager 208 can associate different permission levels, different business rules and/or different configuration settings for a user once the user is authorized to access the data aggregation system 102. The example record manager 208 can then determine which information to import and/or to mask in the local records 210 based on the permission level associated with the user.

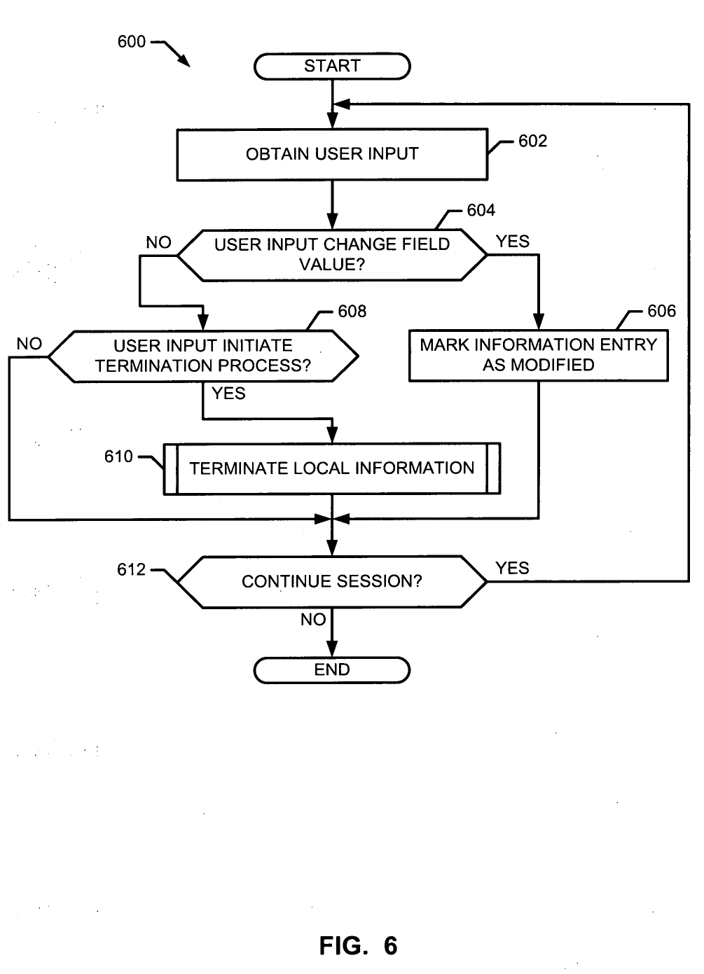

At block 520, the data aggregation system 102 presents the patient information to the user. For example, the record manager 208 can cause the user interface 106 to display information imported by the data importer 216. At block 522, the data aggregation system 102 monitors user input via interactions with the workstation 104 and/or the user interface 106. For example, the example modification monitor 218 (FIG. 2) can monitor user selections received via the example external interface 202. In some examples, the user input can include instructions to the data aggregation system 102 to modify a value, view additional information, close the local record (e.g., the data table in the records database 210), end the current session, etc. Monitoring user input is described in further detail below in connection with FIG. 6.

At block 524, the data aggregation system 102 determines whether to end the current session. If, at block 524, the data aggregation system 102 determines to continue the current session (e.g., the user is interacting with the workstation 104 and/or the user interface 106), control returns to block 514 to query the available information system(s) for information. Otherwise, if, at block 524, the data aggregation system 102 determines to end the current session (e.g., due to a session logout process, an information termination process, a workstation shutdown event, etc.), the session handler 204 logs the user out of the current session and the example process of FIG. 5 ends.

The example method of FIG. 6 monitors user input to determine whether to modify the update flag status of information at the example data aggregation system 102 (FIGS. 1 and/or 2). The example method of FIG. 6 may be used to implement block 522 of FIG. 5. The example method of FIG. 6 begins at block 602 when the example data aggregation system 102 obtains user input. For example, the example external interface 202 can receive user input via the example workstation 104 and/or the example user interface 106 (FIG. 1). At block 604, the data aggregation system 102 determines whether the user input corresponds to changing the value of information in the records database 210. For example, the modification monitor 218 can determine whether the user modified the example field value 304 of an information entry in the data table 300 (FIG. 3). If, at block 604, the modification monitor 218 determines the user input corresponds to changing the value of an information entry in the records database 210, then, at block 606, the data aggregation system 102 marks the information entry as modified. For example, the modification monitor 218 can set the update flag field 312 of the corresponding information entry (e.g., toggle the value of the update flag field 312) in the data table 300. Control then proceeds to block 612 to determine whether to continue the session.

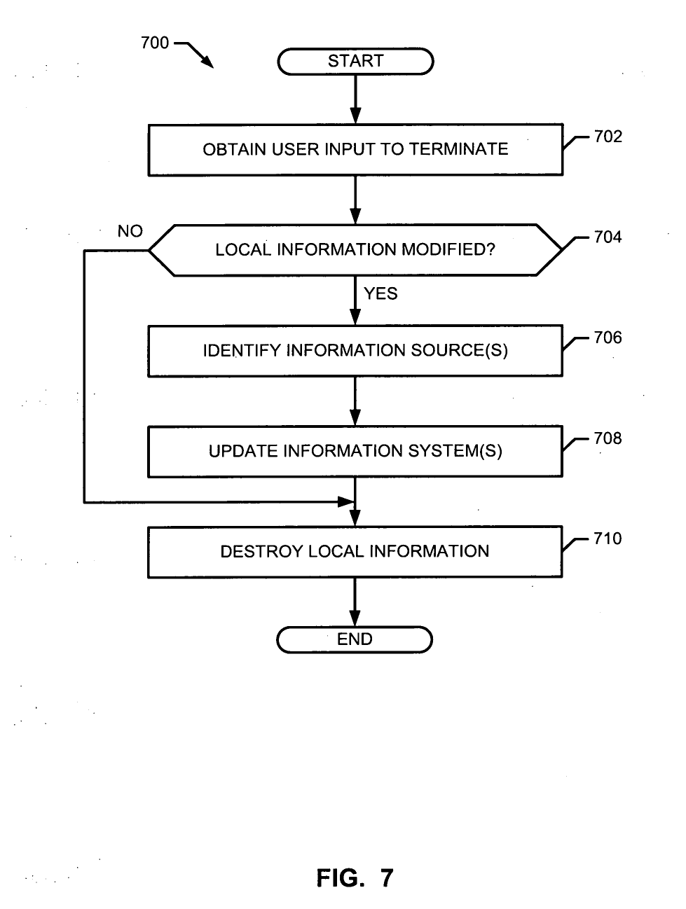

Otherwise, if, at block 604, the modification monitor 218 determines that the user input does not correspond to changing a field value, then, at block 608, the example data aggregation system 102 determines whether the user input initiates a termination process. In some examples, the session handler 204 determines whether the user initiated a session logout process. For example, the user may use the workstation 104 and/or the user interface 106 to instruct the data aggregation system 102 to log the user out of the current session. In some other examples, the record manager 208 can determine whether the user initiated a local record closing process. For example, the user may desire to review information for a second patient and close the data table 300 imported for a first patient. If, at block 608, the data aggregation system 102 determines that the user input does initiate a termination process, then, at block 610, the example data aggregation system 102 terminates the local information (e.g., the information imported from the information systems 108, 110-112) in the records database 210. Terminating local information is described in further detail below in connection with FIG. 7.

Otherwise, if, at block 608, the data aggregation system 102 determines that the user input does not initiate a termination process (e.g., the user selects to review additional information, the user desires to compare information for a first patient and a second patient, etc.), control proceeds to block 612 to determine whether to continue the session. If, at block 612, the data aggregation system 102 determines to continue the current session (e.g., the user is interacting with the workstation 104 and/or the user interface 106 by selecting to review additional information, obtain information for a second patient, etc.), control returns to block 602 to obtain additional user input. Otherwise, if, at block 612, the data aggregation system 102 determines to end the current session (e.g., due to a session logout process, a workstation shutdown event, etc.), the session handler 204 logs the user out of the current session and the example process of FIG. 6 ends.

The example method of FIG. 7 terminates local information at the example data aggregation system 102 of FIGS. 1 and/or 2. The example method of FIG. 7 may be used to implement block 610 of FIG. 6. The example method of FIG. 7 begins at block 702 when the data aggregation system 102 receives a termination instruction. For example, the session handler 204 can receive instructions to initiate a session logout process, the record manager 208 can receive instructions to initiate a local record closing process, and/or the data aggregation system 102 can receive notice of a workstation shutdown event, etc. At block 704, the data aggregation system 102 determines whether information in the records database 210 (e.g., the example data tables 300 and/or 400 of FIGS. 3 and/or 4, respectively) was modified by the user during the current session. For example, the example system updater 220 (FIG. 2) can parse the data table 400 to determine whether the data table 400 includes an information entry with a set update flag 412. If, at block 704, the data aggregation system 102 determines that the information in the records database 210 is unmodified (e.g., the field values are the same as when the information was imported from the source information system(s)), then control proceeds to block 710 to destroy the information imported by the data aggregation system 102 for the queried patient (e.g., the information imported from the information systems 108, 110-112).

Otherwise, if, at block 704, the data aggregation system 102 determines that information in the records database 210 was modified (e.g., the update flag 412 is set for an information entry), then, at block 706, the data aggregation system 102 identifies the source of the information. For example, the system updater 220 can parse the source information system field 306 of the data table 300 to identify the information system(s) from which the information was imported. At block 708, the data aggregation system 102 updates the source information system(s). For example, the system updater 220 can push the updated field values to the respective source information system(s). At block 710, the data aggregation system 102 destroys the information imported by the data aggregation system 102 to the records database 210 for the queried patient. For example, the record manager 208 can erase the information in the data table 300, can write over the information in the data table 300, can delete links to the information in the data table 300, etc. The record manager 208 can also cause the session handler 204 to disconnect (e.g., log the user out) from the available information systems. The example method of FIG. 7 then ends.

FIG. 8 is a block diagram of an example processor platform 800 capable of executing the instructions of FIGS. 5-7 to implement the data aggregation system 102 of FIGS. 1 and/or 2. The processor platform 800 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 800 of the illustrated example includes a processor 812. The processor 812 of the illustrated example is hardware. For example, the processor 812 can be implemented by one or more integrated circuits, logic circuits, microprocessors or controllers from any desired family or manufacturer.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), and/or a PCI express interface.

In the illustrated example, one or more input devices 822 are connected to the interface circuit 820. The input device(s) 822 permit(s) a user to enter data and commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 820 of the illustrated example, thus, typically includes a graphics driver card, a graphics driver chip or a graphics driver processor.

The interface circuit 820 of the illustrated example also includes a communication device such as a transmitter, a receiver, a transceiver, a modem and/or network interface card to facilitate exchange of data with external machines (e.g., computing devices of any kind) via a network 826 (e.g., an Ethernet connection, a digital subscriber line (DSL), a telephone line, coaxial cable, a cellular telephone system, etc.).

The processor platform 800 of the illustrated example also includes one or more mass storage devices 828 for storing software and/or data. Examples of such mass storage devices 828 include floppy disk drives, hard drive disks, compact disk drives, Blu-ray disk drives, RAID systems, and digital versatile disk (DVD) drives.

The coded instructions 832 of FIGS. 5-7 may be stored in the mass storage device 828, in the volatile memory 814, in the non-volatile memory 816, and/or on a removable tangible computer readable storage medium such as a CD or DVD.

From the foregoing, it will appreciate that the above disclosed methods, apparatus and articles of manufacture aggregate information from local and/or foreign information systems for presentation as a unified record without importing the information for permanent storage at a local system.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Additionally or alternatively, while the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A system to present information for a patient from different information systems at a local system, the system comprising:
a session handler to initiate communication with a first information system and a second information system in response to initiation of a user session;
a record manager to generate a local record in the local system in response to initiation of the user session at the local system, the local record to be dynamically generated to include information from the first information system and the second information system organized as a unified record, separate from the first information system and the second information system, for review and modification in the user session via the local system;
a data importer to import first patient information from the first information system and second patient information from the second information system to the local record as information entries to provide the local record at the local system for the user session by combining the first patient information and the second patient information for review and modification during the user session via the local system;
a modification monitor to:
evaluate whether an input received at the local system for the local record modified an information entry in the local record by comparing an original value of the information entry to a current value of the information entry, the original value determined when the information entry is imported to the local record from the corresponding first information system or second information system;
flag an information entry in the local record as modified when the current value is different than the original value associated with the information entry;
unflag the information entry as modified when (1) the current value is the same as the original value and (2) the information entry is flagged as modified; and
a system updater to, upon receipt of a termination instruction:
review the local record to process the information entry in the local record; and
when the information entry is flagged as modified, (1) identify a source information system associated with the information entry as one of the first information system or the second information system and (2) update an information entry at the source information system based on the information entry flagged as modified in the local record;
wherein, upon completion of the review of the local record, the record manager is to delete the local record from the local system and the session handler is to disconnect the user session from the first information system and the second information system,
wherein at least of the session handler, the record manager, the data importer, and the modification monitor is implemented by a processor.

2. A system as defined in claim 1, wherein the data importer is to import the first patient information and the second patient information to the local record unchanged.

3. A system as defined in claim 1, wherein the session handler is to:
authenticate a clinical user during a user session; and
associate a permission level with the clinical user.

4. A system as defined in claim 3, wherein the record manager is to facilitate presentation of the first patient information and the second patient information based on the associated permission level.

5. A system as defined in claim 4, wherein the record manager is to mask a portion of the first patient information.

6. A system as defined in claim 5, further including:
an interface to obtain user input at the local system, wherein the user input is a hover action over the masked portion of the first patient information; and
the record manager to determine whether the permission level associated with the clinical user permits unmasking the masked portion of the first patient information, and the record manager to, based on the determination, unmask the masked portion of the first patient information.

7. A system as defined in claim 1, wherein the termination instruction includes initiation of a user logout process.

8. A system as defined in claim 1, further including a query manager to utilize a patient identifier to identify a first query key that is associated with the first information system to import the first patient information and to identify a second query key that is associated with the second information system to import the second patient information.

9. A system as defined in claim 1, wherein the first information system is to be connected to the local system via a local network and the second information system is to be connected to the local system via an external network.

10. A tangible machine readable storage medium comprising instructions that, when executed, cause a machine to at least:
initiate communication with a first information system and a second information system in response to initiation of a user session at a local system, the first information system connected to the local system via a local network, the second information system connected to the local system via an external network;
utilize a patient identifier to identify a first query key associated with the first information system and a second query key associated with the second information system;
generate a local record in the local system in response to initiation of the user session at the local system, the local record to be dynamically generated to include information from the first information system and the second information system organized as a unified record, separate from the first information system and the second information system, for review and modification in the user session via the local system;
import first patient information from the first information system via the first query key to the local record as one or more information entries and import second patient information from the second information system via the second query key to the local record as one or more information entries to provide the local record at the local system for the user session by combining the first patient information and the second patient information for review and modification during the user session via the local system;
evaluate whether an input received at the local system for the local record modified an information entry in the local record by comparing an original value of the information entry to a current value of the information entry, the original value determined when the information entry is imported to the local record from the corresponding first information system or second information system;
flag the information entry in the local record as modified when the current value different than the original value associated with the information entry; and
unflag the information entry as modified when (1) the current value is the same as the original value associated with the information entry and (2) the information entry is flagged as modified;
upon receipt of a termination instruction, review the local record to process the information entry in the local record;
when the information entry is flagged as modified, (1) identify a source information system associated with the information entry as one of the first information system or the second information system and (2) update a corresponding information entry at the source information system based on the information entry flagged as modified in the local record;
delete, upon completion of the review of the local record, the local record from the local system; and
disconnect the user session from the first information system and the second information system.

11. A tangible machine readable storage medium as defined in claim 10, wherein the instructions further cause the machine to:
authenticate a clinical user during a user session;
associate a permission level with the clinical user; and
facilitate presentation of the first patient information and the second patient information based on the associated permission level.

12. A tangible machine readable storage medium as defined in claim 10, wherein the instructions further cause the machine to mask a portion of the first patient information.

13. A tangible machine readable storage medium as defined in claim 10, wherein the termination instruction includes initiating a user logout process.

14. A method to present, at a local system, information for a patient retrieved from a first information system and a second information system, the method comprising:
initiating communication with the first information system and the second information system, the first information system connected to the local system via a local network, the second information system connected to the local system via an external network;
generating a local record in the local system in response to initiation of the user session at the local system, the local record to be dynamically generated to include information from the first information system and the second information system organized as a unified record, separate from the first information system and the second information system, for review and modification in the user session via the local system;
importing first patient information from the first information system to the local record as one or more information entries and importing second patient information from the second information system to the local record as one or more information entries to provide the local record at the local system for the user session by combining the first patient information and the second patient information for review and modification during the user session via the local system;
evaluating whether an input received at the local system for the local record modified an information entry in the local record by comparing an original value of the information entry to a current value of the information entry, the original value determined when the information entry is imported to the local record from the corresponding first information system or second information system;
when the current value is different than the original value associated with the information entry in the local record, flagging the information entry as modified;
when (1) the current value is the same as the original value associated with the information entry and (2) the information entry is flagged as modified, unflagging the information entry;
upon receipt of a termination instruction, reviewing the local record to process the information entry in the local record;
when the information entry is flagged as modified, (1) identifying a source information system associated with the information entry as one of the first information system or the second information system and (2) updating a corresponding information entry at the source information system based on the information entry flagged as modified in the local record;
deleting, upon completion of the review of the local record, the local record from the local system; and
disconnecting the user session from the first information system and the second information system.

15. A method as defined in claim 14, wherein the first patient information and the second patient information are imported to the local record unchanged.

16. A method as defined in claim 14, further including utilizing a patient identifier to identify a first query key associated with the first information system to import the first patient information and a second query key associated with the second information system to import the second patient information.

17. A method as defined in claim 14, further including:
authenticating a clinical user during a user session;
associating a permission level with the clinical user; and
presenting the first patient information and the second patient information based on the associated permission level.

18. A method as defined in claim 17, wherein presenting the first patient information further includes masking a portion of the first patient information.

19. A method as defined in claim 18, further including:
obtaining user input at the local system, wherein the user input is a hover action over the masked portion of the first patient information;
determining whether the permission level associated with the clinical user permits unmasking the masked portion of the first patient information; and
based on the determination, unmasking the masked portion of the first patient information.

20. A method as defined in claim 14, wherein the termination instruction includes initiating a user logout process.
